(19) United States
(12) Patent Application Publication
(10) Pub. No.: US 2018/0280807 A1
(43) Pub. Date: Oct. 4, 2018

(54) Interactive recruitment game

(71) Applicant: Hundred5 OÜ, Tallinn (EE)

(72) Inventor: Alari Aho, Tallinn (EE)

(73) Assignee: Hundred5 OÜ, Tallinn (EE)

(21) Appl. No.: 15/470,921

(22) Filed: Mar. 28, 2017

(51) Int. Cl. A63F 13/798; A63F 13/335; G06Q 10/10

(52) U.S. Cl. CPC A63F 13/798; G06Q 10/1053; A63F 13/335

(57) ABSTRACT

Disclosed is an automated recruitment game for identifying candidates having desired traits. The game can include some or all of the following computer implemented steps: creating a user identity for each candidate, associating the user identity with a specific electronic device, creating a game tailored to identify a plurality of desired traits in candidates, presenting the tailored game to the candidate on the specific electronic device associated with the candidate's user identity, wherein the manner in which the tailored game is presented is selected based on a degree of desired authentication of the candidate, scoring the candidates game play of the tailored game and comparing the score to a set of limits, and automatically informing the candidate of at least one next step in a recruitment process based on the comparison of the candidates score to the set of limits.

### FIELD OF INVENTION

The present invention relates to the fields of human resources management and interactive gaming. In particular, described are interactive recruitment procedures including incorporating entertainment for enhancing the job seeking and candidate acquisition process. Additionally aspects relate to enhancement of identity security of job seekers.

### BACKGROUND OF INVENTION

Ask any business about its top challenges and recruiting is for sure somewhere on that list. Regardless of the industry or the position, it is always difficult to find good people to join your company.

For one, it can be hard to stand out. Standing out from 5.5 million job openings is almost impossible and finding a perfect fit is exhausting for both sides. Job boards are loaded with thousands of similar offers—all heavily text-based yet vague. And most people only scan these listings without reading.

Another issue is that it is hard to engage good candidates. The best people are most likely occupied and they rarely browse job boards. Sending resumes or cover letters as a first step can be too high of a threshold to overcome, which makes the 5% of desired candidate for a company almost impossible to engage.

Current recruitment processes are largely driven by decisions based on CVs or Resumes. One issue with CVs are that they are not comparable documents—e-g-, contain different formats, content and styles. As a result, a recuirter will end up with a lot of uncontrollable facts and often no good way to make rational decisions. With CVs a company can set somewhat arbitrary parameters (age, schools, previous work experience, etc) which eliminate many potentially good candidates without even giving them a chance.

Yet another issue is a flood of mediocre candidates. HR is often flooded with job applicants who spam all possible openings. Over 95% of people applying for a position are not a match. A company however still needs to spend a lot of time handling their CVs and responding to emails.

Another major issue deals with typically slow communication times with good candidates. As a hiring manager needs to spend 95% of their time communicating with people they do not want, they will end up answering slowly to the best ones. These desired candidates might be long gone once the manager finally ends up contacting them.

### SUMMARY OF THE INVENTION

Disclosed herein is a method for presenting a game to a candidate in a recruitment process comprising the steps of; creating a user identity for each candidate, associating the user identity with a specific electronic device, creating a game tailored to identify a plurality of desired traits in candidates, presenting the tailored game to the candidate on the specific electronic device associated with the candidate's user identity, wherein the manner in which the tailored game is presented is selected based on a degree of desired authentication of the candidate, scoring the candidates game play of the tailored game and comparing the score to a set of limits, and automatically informing the candidate of at least one next step in a recruitment process based on the comparison of the candidates score to the set of limits.

According to certain embodiments, a tailored game can be presented as a position-related, time restricted game to the candidate. Automatically informing the candidate includes can include an email or other electronic message to be sent to the candidate informing them of a next step in the recruitment process. Additionally, there can be a step of searching a database for desired traits and/or scores and automatically informing the associated candidates of a next step in a recruitment process.

It is considered that companies that cannot find creative ways to find employees, are unable to grow efficiently. Good candidates see opportunities everywhere and are fast to judge a company. Thus, HR should cooperate with unit leaders and use a combination of the mechanisms disclosed herein to better attract and retain the desired candidates.

For example, using short gamified tests, that require for example up to 15 minutes of applicant's time. Engaging people with a simple but catchy test can lower the barrier for applying and gives them a good understanding of the job requirements. Automatic scoring will help to make decisions quickly. A lot of manual work can be avoided by weeding out unqualified and uninterested candidates.

Make sure interested and interesting candidates are engaged quickly and followed up with a clear and well-communicated path forward the hiring process.

### BRIEF DESCRIPTION OF THE DRAWINGS

FIG. 1 shows an example flow chart for using a game in a recruitment process.

FIG. 2 shows another example flow chart for using a game in a recruitment process.

### DETAILED DESCRIPTION OF EXEMPLARY EMBODIMENTS

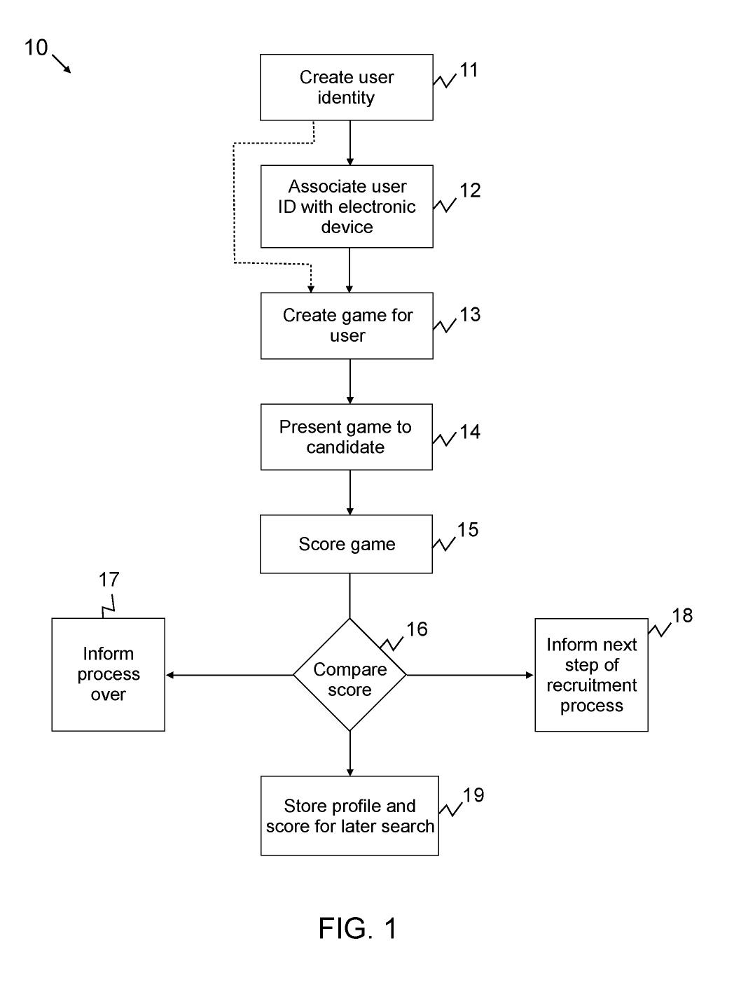

A game provided on an electronic device can help in several phases and aspects of a more traditional recruitment process. According to one example, there is an automated process as shown in FIG. 1.

The automated recruitment process 10 can include a recruitment game for identifying candidates having desired traits. A process in accordance with the present invention may have some or all of the following step, ordered or unordered; creating a user identity for a candidate 11, associating the user identity with a specific electronic device 12, creating a game tailored to identify a plurality of desired traits in candidates 13, presenting the tailored game to the candidate 14, which can be on the specific electronic device associated with the candidate's user identity or another electronic device, scoring the candidates game play of the tailored game 15, comparing the score to a set of limits 16 and automatically informing the candidate of at least one next step in a recruitment process 17, 18. The process may also include storing information 19, such as profile information of the candidate and/or score results, for later use.

The manner in which the tailored game is presented can be selected based on a degree of desired authentication of the candidate. For example, the game can be presented as a position and/or time restricted game. The game can also be presented on an electronic device having a camera and/or microphone. The camera and/or microphone can be used to authenticate the user at one or more times during the game. For example, for a higher degree of authentication, the game can include having the user respond orally and the user can be authenticated using voice recognition software. Additionally, for example for a higher degree of authentication, the game can be presented to the user in front of a screen with a video camera which records the image of the user as they play. Such an example can insure that the game response is provided by the actual candidate and not by a surrogate. Other examples include tracking the IP address of the candidate/respondent.

The user identity can be created by registering a candidate through a pre-existing and verified online site. It can also be created during, before, after and/or in connection with the creation of a candidate profile having information relating to the identity and potentially a full or partial history of the candidate.

The game can be tailored to identify one or more traits of a candidate. This can be achieved by creating a specific game for a position or for determining one or more traits. Additionally a game can be tailored by selecting a group of mini or sub games or game features and combining them into a tailored game. These mini games, sub games or game features can be created for the job posting or they can be selected from a database, either local or online, having a plurality of such games and features. Examples of games, mini games, sub games and game features are, for example, puzzles, trivia, critical thinking exercises, first person games, third person games, strategy games, psychological games and other question & answer based games.

The game can be tailored and set prior to presentation to the candidate. The game may also be tailored during game play based on the responses and/or game play of the candidate.

The game can be scored in a variety of manners and the scoring method can be based on the type of game and/or results desired. For example, in a questionnaire or puzzle there can be a correct answer and/or time to respond. There may also be a question with no correct answer and the score can be based on how the candidate responds. Other games may have a goal with multiple paths and a more complex scoring algorithm.

The candidates score can be compared to a set of limits. The set of limits can be, for example, a predefined overall score limit, a set of individual pass/fail limits from different games or portions of a game, a mathematical average of more than one score from different games or portions of a game or a combination thereof. The set of limits can also be a dynamic limit which is impacted by earlier candidate's scores. The set of limits can also be a single limit.

Once the candidates performance has been scored and/or compared, the candidate can be automatically informed of their results and/or a next step in the recruitment process. They can be informed directly on the screen of the electronic device which the game was presented on. The automatic informing of the candidate can also include causing an email or other electronic message to be sent to the candidate. Such an email or other electronic message can inform them of their score and/or a next step in the recruitment process.

One example of a next step is that the candidate did not qualify for further consideration. There may also be a request for the candidate to provide more information, such as a resume, CV or cover letter or answer additional questions. The information may also indicate the candidates information and score are being stored for later use in this or another recruitment process.

The message, be it an email or other electronic message, can be selected from a plurality of pre-written options or wherein the email or other electronic message is created and/or personalized for the candidate by compiling multiple pre-written sections into a personalized electronic message.

If information about a candidate is stored, for example in a database, then a recruitment process can also include, for example, searching the database for desired traits and/or scores and automatically informing the associated candidates of a next step in the same, or a new, recruitment process.

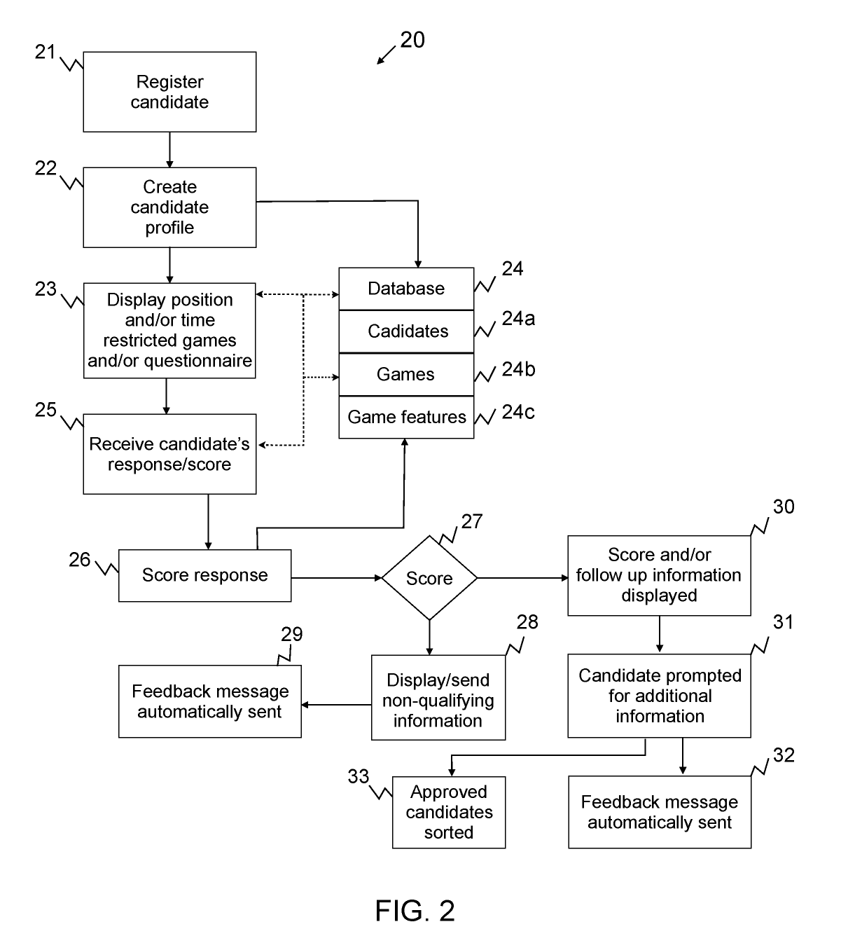

FIG. 2 shows another example recruitment method flow chart 20 involving a game. The process can begin by registering a candidate 21 and/or creating a user identity for the system. This registration can come via, for example, social media profiles of the candidate or another established and accessible source, such as an online source. A candidate profile can be created 22 for the registered candidate. The profile can be as simple or as in-depth as desired. The profile can be stored in a database 24, for example in a section for candidates 24a. The database 24 can include multiple sections, or can be comprised of multiple separate databases, for, for example, candidates information 24a, games 24b or game features 24c. If a game is a questionnaire, then multiple different questionnaires can be stored in the game database 24b for example. If the game is a questionnaire, then multiple questions or groups of questions can be stored as game features 24c and compiled to create a single game questionnaire.

A game can be displayed 23 to the candidate. The game can be position and/or time restricted. The game can also be, or contain, a questionnaire. The candidates response or score can be received 25. These can be stored in the database 25. They can also be used to modify the displayed game/questionnaire which is still being displayed to the candidate. Once the game/questionnaire is finished it can be scored 26 as a whole. These results can again be stored in the database if so desired. The score can then be compared 27 to a threshold. If above a threshold the score and/or follow-up information can be displayed 30. The candidate can be prompted to enter additional information 31. A feedback message can also be automatically sent to the candidate 32. The feedback message can include information about a next step or steps in the recruitment process. The approved candidates can also be automatically sorted 33 for, for example, a hiring coordinator. For candidates who's score is below a threshold then information and/or their score can be displayed indicating that they have not met the standard. A feedback message can also be automatically sent to these candidates.

Furthermore, there can be a non-transitory computer readable medium having stored thereon a set of computer readable instructions for causing a processor of a computing device to carry out the methods and steps described above.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. An automated recruitment game for identifying candidates having desired traits, said game comprising the computer implemented steps of:
creating a user identity for each candidate,
associating the user identity with a specific electronic device,
creating a game tailored to identify a plurality of desired traits in candidates, wherein the game is tailored to identify a plurality of desired traits by selecting a subset of specific games or game features from a database of earlier created games and game features,
presenting the tailored game to the candidate on the specific electronic device associated with the candidate's user identity as a position-related, time restricted game to the candidate, wherein the manner in which the tailored game is presented is selected based on a degree of desired authentication of the candidate,
scoring the candidates game play of the tailored game and comparing the score to a set of limits, and
automatically informing the candidate of at least one next step in a recruitment process based on the comparison of the candidates score to the set of limits by causing an email or other electronic message to be sent to the candidate informing them of a next step in the recruitment process.

2. (canceled)

3. The automated recruitment game according to claim 1, wherein the game is further tailored during the play of the user based on the users earlier game play.

4. (canceled)

5. The automated recruitment game according to claim 1, wherein the games are selected from the group of; puzzles, trivia, critical thinking exercises, first person games, third person games, strategy games, psychological games and other question & answer based games.

6. The automated recruitment game according to claim 1, wherein the user identity is created by registering a candidate through a pre-existing and verified online site.

7. The automated recruitment game according to claim 1, wherein the set of limits is a predefined overall score limit, a set of individual pass/fail limits from different games or portions of a game, or a mathematical average of more than one score from different games or portions of a game.

8. The automated recruitment game according to claim 1, wherein the set of limits is a dynamic limit which is impacted by earlier candidate scores.

9. (canceled)

10. The automated recruitment game according to claim 1, wherein the email or other electronic message is selected from a plurality of pre-written options or wherein the email or other electronic message is created and/or personalized for the candidate by compiling multiple pre-written sections into a personalized electronic message.

11. The automated recruitment game according to claim 1, further comprising, storing and maintaining a database of candidates' game performance and/or scores.

12. The automated recruitment game according to claim 11, further comprising, searching the database for desired traits and/or scores and automatically informing the associated candidates of a next step in a recruitment process.

13. A non-transitory computer readable medium having stored thereon a set of computer implementable instructions for an automated recruitment game for identifying candidates having desired traits, comprising said computer implementable instructions capable of causing the processor of a computing device to carry out the steps of:
creating a user identity for each candidate,
associating the user identity with a specific electronic device,
creating a game tailored to identify a plurality of desired traits in candidates, wherein the game is tailored to identify a plurality of desired traits by selecting a subset of specific tames or game features from a database of earlier created games and game features,
presenting the tailored game to the candidate on the specific electronic device associated with the candidate's user identity as a position-related, time restricted game to the candidate, wherein the manner in which the tailored game is presented is selected based on a degree of desired authentication of the candidate,
scoring the candidates game play of the tailored game and comparing the score to a set of limits, and
automatically informing the candidate of at least one next step in a recruitment process based on the comparison of the candidates score to the set of limits by causing an email or other electronic message to be sent to the candidate informing them of a next step in the recruitment process.

14. The automated recruitment game according to claim 1, wherein the tailored game is created with at least one task for the user of responding orally, and wherein the tailored game is presented in a way that a user's oral response can be authenticated using voice recognition software for authenticating the user.

15. The automated recruitment game according to claim 1, wherein the tailored game is presented to the candidate such that a user can be monitored by a camera during presentation in order to authenticate the user's response to the game.

16. The automated recruitment game according to claim 13, wherein the game is further tailored during the play of the user based on the users earlier game play.

17. The automated recruitment game according to claim 13, wherein the games are selected from the group of; puzzles, trivia, critical thinking exercises, first person games, third person games, strategy games, psychological games and other question & answer based games.

18. The automated recruitment game according to claim 13, wherein the set of limits is a dynamic limit which is impacted by earlier candidate scores.
